(19) United States
(12) Patent Application Publication
(10) Pub. No.: US 2011/0153603 A1
(43) Pub. Date: Jun. 23, 2011

(54) TIME SERIES STORAGE FOR LARGE-SCALE MONITORING SYSTEM

(75) Inventors: Nicolas Adiba, Santa Clara, CA (US); Yu Li, Milpitas, CA (US); Arun Gupta, Fremont, CA (US)

(73) Assignee: YAHOO! INC., Sunnyvale, CA (US)

(21) Appl. No.: 12/640,429

(22) Filed: Dec. 17, 2009

(51) Int. Cl. G06F 17/30

(52) U.S. Cl. 707/737; 707/E17.005

(57) ABSTRACT

Methods and apparatus are described for collecting and storing large volumes of time series data. For example, such data may comprise metrics gathered from one or more large-scale computing clusters over time. Data are gathered from resources which define aspects of interest in the clusters, such as nodes serving web traffic. The time series data are aggregated into sampling intervals, which measure data points from a resource at successive periods of time. These data points are organized in a database according to the resource and sampling interval. Profiles may also be used to further organize data by the types of metrics gathered. Data are kept in the database during a retention period, after which they may be purged. Each sampling interval may define a different retention period, allowing operating records to stretch far back in time while respecting storage constraints.

### BACKGROUND OF THE INVENTION

The present invention relates generally to monitoring computer systems, and more specifically to managing large volumes of time series data.

Large-scale systems such as clusters, computing grids, and cloud storage systems require sophisticated monitoring tools. Statistics such as network throughput, CPU utilization, number of requests served, host uptimes as well as statistics about application level abstractions (such as particular APIs, storage or processing groups) are needed for many purposes. These types of data aid in capacity planning, failure detection, and system optimization, among other uses.

As useful, or possibly even more useful than current operating statistics are historical ones extending back in time. How the system performed in the past and what has changed over time provide vital information. Thus performance metrics are generally saved as time series data, which are sequences of data points measured over a span of time, often (but not necessarily) spaced at uniform time intervals. Peering back into the past of system operation is especially useful since the operator may not know ahead of time which data will be needed. For instance, a cluster originally tasked with serving web requests may later be used as a messaging system. Similarly, historical data are useful for spotting changes as new version of cluster software are deployed over time. Correlating changes in cluster behavior with these types of system events provides valuable insights.

While existing tools support monitoring of large-scale systems, they leave much to be desired. One example is the industry standard RRDtool, an open source program released by Tobias Oetiker. In such conventional tools, write performance is slow when processing millions of data points from thousands of nodes, as large clusters can easily produce. In addition, the storage setup for existing tools is typically inflexible. The metrics to be logged must be specified in advance; adding new metrics is tedious and time-consuming, and may require making performance tradeoffs. Logging intervals (every hour, day, week, etc) are likewise difficult to change. Data is expected to arrive in the order generated, which frequently does not occur in heavily loaded real-world systems. Space is pre-allocated for the logging intervals specified which can result in very high I/O load when many new time series are created. Data are gathered and recorded in one dimension such as by host, by task, or by event, making multi-dimensional analysis difficult. Finally, tools like RRDtool interpolate data points to fit the requested time periods. This makes raw data from the nodes inaccessible, camouflaging momentary spikes and confounding analysis. While existing relational database tools address some of these shortcomings, they fall short on others.

### SUMMARY OF THE INVENTION

According to the present invention, methods, apparatus, and computer program products are presented for efficiently storing large volumes of time-series data. A plurality of time series data from one or more computing clusters are received at a computing device. The time series data include a resource identifier, an order in which the data point occurs, and one or more metrics by which the corresponding resource may be characterized. The device aggregates the time series data into sample intervals, where each sample interval corresponds to a different time resolution. The data are stored in a metrics database organized according to the sample intervals, resource identifiers, and profiles comprising a group of metrics. Data are stored in the metrics database during a retention period associated with the corresponding sample interval. After the retention period, expired data are removed from the metrics database. In some embodiments, the device processes both existing data imported from another source and live data recently generated by the computing clusters without disrupting the real-time collection of live data.

A further understanding of the nature and advantages of the present invention may be realized by reference to the remaining portions of the specification and the drawings.

### BRIEF DESCRIPTION OF THE DRAWINGS

FIG. 1 shows an example environment for practicing embodiments of the invention.

FIG. 2 depicts a processing and storage entity according to a specific embodiment of the invention.

FIG. 3 illustrates a particular process for practicing embodiments of the invention.

FIG. 4 shows a particular implementation of a data center monitoring system according to a specific embodiment of the invention.

FIG. 5 illustrates a diverse network environment with which implementations of the invention may interact.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Techniques of the present invention enhance the collection and storage of time series data from a computer cluster. Time series data are sequences of data points measured over a span of time, often (but not necessarily) spaced at uniform time intervals. According to various embodiments, data points are associated with a resource, which describes a set of aspects in the system or dimensions of the time series data. Resources may be identified by name, number, or any other unique identifier. For instance, a resource named “web search” may be associated with aspects (or dimensions) such as TCP traffic on port 80 for the URL /help/search.php on any host in the cluster. A resource database may be used to translate a set of dimensions into a resource identifier which indexes the encompassed dimensions in a metrics database. The metrics database organizes and stores monitoring data for each named resource according to a configurable sampling resolution of the data. For instance, data could be sampled every minute, 10 minutes, hour, 6 hours, or any arbitrary time period. Multiple sampling resolutions of the same data may be defined such as, for example, storing “web search” data sampled every 1 minute for 1 month, every 10 minutes for 3 months, every 1 hour for 1 year, and every 6 hours for 3 years.

According to some embodiments, an aggregation function may be used when data points arrive more frequently than the sampling period. For example, a node may send cpu load data every 1 minute while the resolution time for that resource is set to 10 minutes. The aggregation function selects from or combines raw data points received during the sampling period to create a single data point for storage. A cache in front of the database may be employed for faster access to the most recent data points. Various techniques are employed by specific implementations to allow for growth of the database to efficiently add new metrics to existing named resources. Data may also be organized by a recording period such as, for example, grouping data sampled every 1 minute in 24-hour chunks. After a configurable retention period has passed, older data may be purged from the system. For instance, 24-hour chunks of data may be preserved for two weeks.

Various embodiments of the invention may be characterized by one or more of the following advantages over conventional systems: dynamic schema management for dynamically adding new time series as the compute grid grows, dynamically adding or removing individual metrics, dynamically adding or removing aggregations of data, dynamically changing time resolutions of stored data, inline resampling of data with deferred writes, which may be randomized over time, improved read performance from ordering time series data by aggregating lower resolution time series, improved read performance by interpolating missing samples to preserve trends, background loading of data while processing live data, read time resampling of data at resolutions other than ones it was collected at, or good on-disk segmentation. These advantages will be further explained with reference to specific embodiments below.

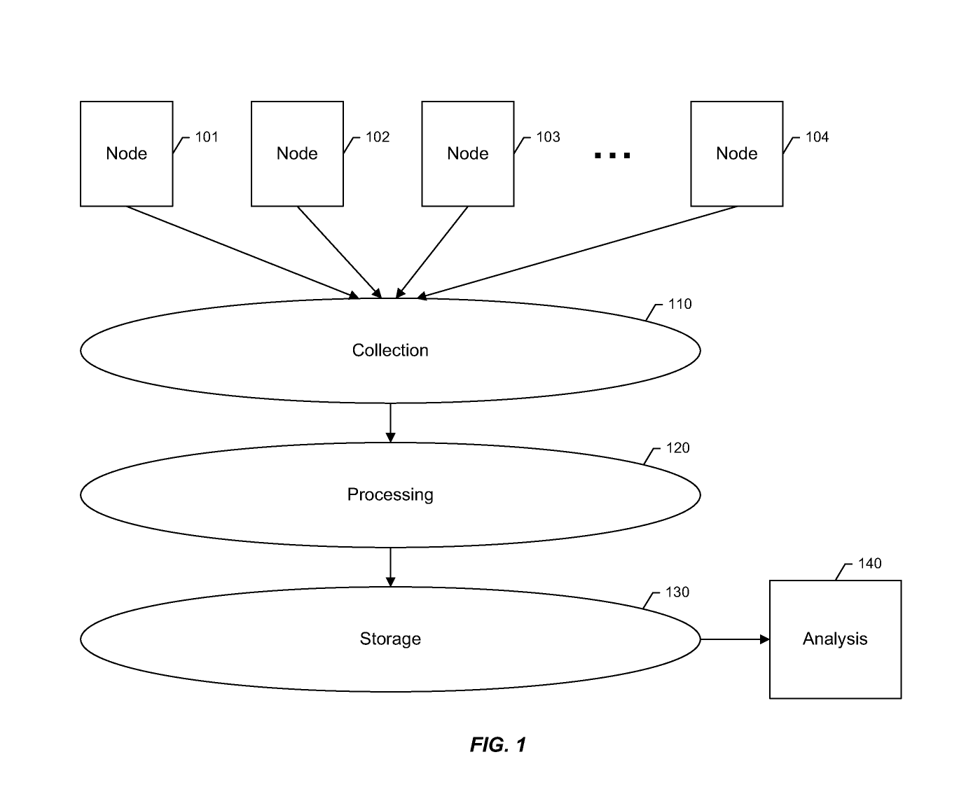

FIG. 1 shows an example environment for practicing specific embodiments of the invention. Nodes 101-104 represent a cluster of computing devices. While four nodes are shown as an example, it will be understood that such a cluster may contain an arbitrary number of machines in any of a wide variety of network configurations. For example, the machines may be colocated in one datacenter or encompass multiple datacenters. The cluster may be used for various purposes, such as processing search requests, hosting web applications, providing storage or computation services, or serving online advertisements, among other possibilities. Whatever its purpose, a service provider associated with the cluster may wish to monitor various aspects of cluster performance. These may include, for example, metrics such as number of requests served, network throughput, I/O operations per second, system load, disk utilization, application latency, application errors, queue backlog and velocity, memory usage, system swap, hit/miss cache ratio, or error/request percentage. Many other metrics of interest that may be monitored in such an environment will be appreciated by those skilled in the art.

To gather the cluster metrics, each node reports data to a metric collection entity 110. Each of entities 110, 120, and 140 may compromise many forms, including one or more processes operating on a single device, multiple connected devices, a distributed network of devices, and so on. The devices may or may not be part of the cluster being monitored. They may also comprise all or part of another cluster. The collection entity may gather the metrics data in many ways. Nodes 101-104 may send metrics to collection entity 110, such as at certain time intervals or on the occurrence of certain events. The collection entity may poll nodes 101-104 for data according to various strategies. Any suitable means of gathering metrics is contemplated by the invention.

Collection entity 110 passes the metrics data to processing entity 120. The processing entity cleans up the raw data for storage. This may include actions such as, for example, discarding bad data, averaging or interpolating data points, and waiting for delayed data to arrive. According to some embodiments, the processing entity also formats the processed data for storage in storage layer 130. Formatting may involve operations such as, for example, sorting, rearranging, or splitting up the data according to source, timestamp, type of metric, or other factors.

When the data is ready for storage, processing entity 120 sends it to storage entity 130, which may comprise any suitable data storage system, such as one or more disk arrays, databases, storage area network (SAN) devices, or storage clusters, among other possibilities. From there, the data may be retrieved by analysis engine 140 for further analysis. For example, engine 140 may prepare reports showing cluster utilization and throughput or plot the number of web requests per second for images. Once the metrics data are stored in storage entity 130, any conceivable business or technical use is contemplated for an analysis engine, including status monitoring, capacity planning, and problem detection.

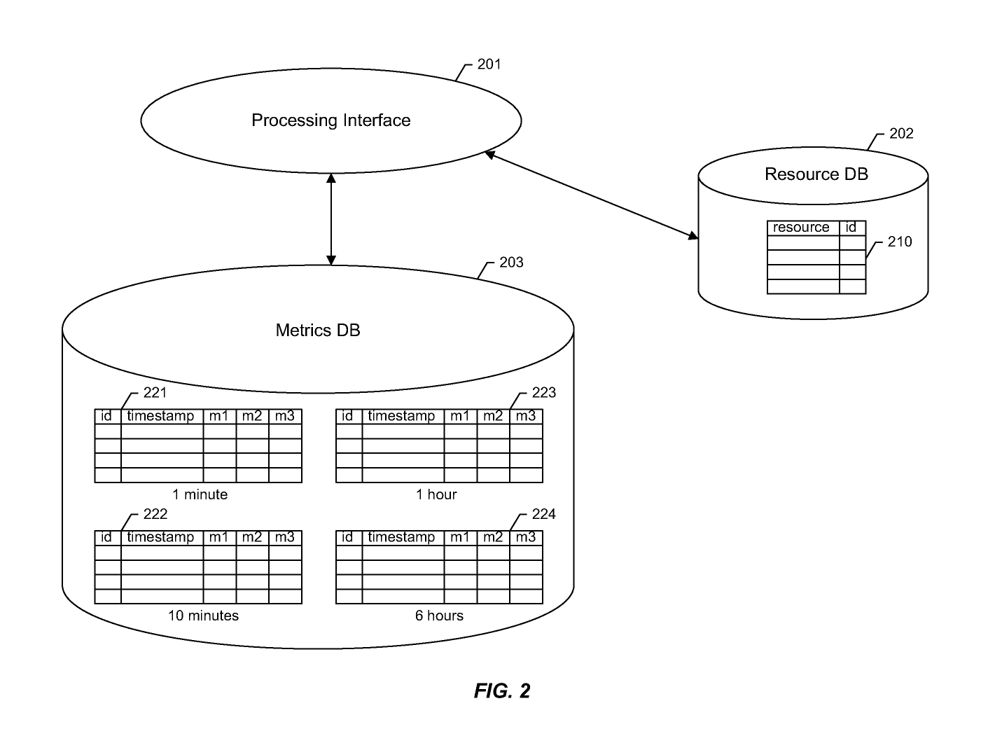

FIG. 2 depicts a processing and storage entity according to a specific embodiment of the invention. Processing interface 201 provides a programmatic interface for a collection entity to deliver data. Interface 201 may be implemented in any suitable fashion, such as an application programming interface (API) for a computer programming language, system calls, message passing, remote procedure calls, signals, network communications, or other techniques known in the art.

According to the embodiment shown, metrics data sent to the processing interface are accompanied by a resource identifier and a timestamp. The resource identifier identifies a collection of metrics. For instance, a resource named “web search” may be assigned to metrics associated with TCP traffic on port 80 for the URL /help/search.php. Such metrics might include, for example, data like number of requests served, number of cache misses, or error frequency. Although resource identifiers are given as descriptive strings of text for expository purposes here, it should be remembered that they may comprise any type of identifier, particularly unique numerical values for indexing in a database. In some embodiments, resources may be represented as a collection of key-value pairs. Continuing the example, the “web search” resource may be represented as a set of key-value pairs {protocol=TCP, port=80, url=/help/search.php}. A named resource may comprise an arbitrary number n of such key-value pairs, corresponding to an n-dimensional space.

The timestamp indicates the order in which the data were generated. It may represent a specific time and date or simply a relative order, such as numbering data points consecutively. Substantial delays may occur between data generation and receipt by the processing interface. For example, the source node may be busy with other jobs and unable to report the data to the collection entity for a time. Including the generation time allows the system to properly sequence data which arrive out of order.

The processing interface may translate the resource name into a unique identifier suitable for use in a metrics database. According to certain embodiments, the processing interface looks up the resource name in a resource database 202. The resource database may contain a table 210 mapping resources to identifiers, as depicted in FIG. 2. In some embodiments, table 210 may be implemented as a search tree on key-value pairs comprising the resource. This allows flexibility in managing the set of resources. Many other implementations are possible, as appreciated by those skilled in the art. In some embodiments, if resource database 202 receives a resource which it has not seen before, it creates a new identifier for the resource. This allows new resources to be quickly and easily added to the system. Any metrics data the collection entity sends will be properly indexed and stored in the storage layer via the processing entity.

With the resource identifier corresponding to the resource, the processing entity stores the data in a metrics database 203. Data are stored in a table such as 221 with fields for the resource identifier (id), the timestamp, and the metrics data, denoted here as fields m1, m2, and m3. Although three metrics fields are shown, any arbitrary number of metrics may be stored in each table. Storing metrics with the described mechanisms scales well to very large systems collecting millions of metrics per minute. The conventional approaches of writing to thousands of files as RRDtool does or even storing metrics in a relational database struggle under this workload.

According to some embodiments, the metrics database relaxes the ACID (Atomicity, Consistency, Isolation, Durability) properties of a conventional relational database. The relaxed ACID properties include guaranteeing any metric will eventually be persisted within x minutes of the time they are received (such as x=20 minutes) instead of immediately. If an application crashes no data is lost, and if a machine crashes up to 20 minutes of data might be missing for a subset of metrics. Restarting after a crash does not require reading data back from the metrics database. Updates can be merged into the database on the next cache flush. For example, suppose a SUM function aggregates data points over a one hour sampling window. Further suppose the cache flushes the partial sum to the database 20 minutes into the window, and the machine crashes 30 minutes into the window. The flushed partial sum persists in the database, while the cached data between 20 and 30 minutes are lost. After a restart, the cache resumes summing new data from scratch (i.e. the sum begins at 0). When the new cached SUM is flushed to storage, the system detects that an older sum already exists in the database for the sample window in question and uses the aggregation function to aggregate the two values (in this case, by summing them). Thus the storage location contains the correct SUM of data from before the flush and after the crash, with only the unflushed data in between missing from the sample.

However, once persisted the data are fully durable. This relaxed persistence guarantee is acceptable because missing data are interpolated on reads from the database if a few samples are missing. As long as monitoring data reflects system trends, it remains useful to administrators. Missing a few windows of data for an event as dramatic as the host crashing is acceptable in most cases. Additionally, incoming data streams may be sent to more than one database to deal with such failure conditions.

According to certain embodiments, metrics database 203 is organized in a way that provides advantages over conventional time series data storage. For instance, both the depicted embodiment and RRDtool allow recording time series with multiple sampling rates and retention periods. As an example, the system may be configured to retain data points sampled every minute for a period of one day, data sampled every ten minutes for one week, data sampled every hour for three months, and data sampled every six hours for two years. Multiple periods may be applied to the same data, such as maintaining web search data according to all of the preceding examples at the same time.

Strategies like this balance the need for records going back in time against the storage requirements for keeping large amounts of data. Unlike RRDtool, however, metrics database 203 incorporates this strategy into the storage system. That is, certain embodiments of the present invention group data by collection period. For example, in the depicted embodiment table 221 stores data sampled in one minute intervals, table 222 stores data sampled in 10 minute intervals, table 223 stores data in one hour intervals, and table 224 stores data in six hour intervals. Incoming data from hundreds or thousands of nodes may be written to one table, such as the one minute sample table 221. This improves locality of reference when writing data. Instead of writing to many files scattered across a disk requiring many disk seeks, the data may be stored in contiguous locations. Additionally, metrics storage space need not be pre-allocated, making adding new resources efficient.

Metrics in larger sampling periods may be determined in various ways. For instance, the processing interface may store all incoming data in the highest resolution table, such as one minute table 221. Lower resolutions can be filled in using the data from higher resolutions. For example, data points in the ten minute table 222 can be constructed from the ten one-minute samples in table 221 for each ten minute time period. The aggregated samples need not occur in regular intervals. For instance, a ten-minute data point may be aggregated from 117 samples scattered at various times throughout the ten-minute interval. Data in other sampling periods may be constructed from any higher-resolution sample as appropriate. For instance, data points sampled at one hour in table 223 may be created by combining sixty one-minute data points from table 221 or six ten-minute data points from table 222. Data created in this manner by aggregating higher-resolution data points are referred to herein as archive data.

An aggregation function performs the task of creating archive data points from higher-resolution ones. Examples of aggregation functions may include, for example, averaging the data points together, taking the minimum, maximum, median, or modal data point, selecting the most recent data point, interpolating a value based on the data points, summing the total of the data points, counting the number of data points, or choosing a random data point from the samples. Similarly, the aggregation function may compensate for incomplete data such as, for example, from samples arriving late or a node that temporarily goes down. Numerous possibilities for aggregation functions will be understood by those skilled in the art. If data arrives more frequently than the highest sampling rate (either at regular intervals or arbitrarily within the sampling interval), an aggregation function may be used there as well. For instance, if data points arrive every 30 seconds, an aggregation function may be used to select data points for the one-minute table.

According to some embodiments, when a data point is to be added to a lower resolution table, e.g., ten-minute table 222, corresponding data points from a higher resolution table, e.g., one minute table 221, may be retrieved. However, some embodiments employ an approach which caches recent data points at, for example, the processing entity. For example, the cache may hold the ten most recent data points for a certain metric. Suppose these data points arrive at the rate of one per minute. When the cache becomes full every ten minutes, the processing entity may write all ten data points to the one-minute table 221 in one batch. It may also combine the ten one-minute data points with an aggregation function into a ten-minute data point. The ten minute data point may be written to the ten-minute table 222. The cache may also hold the most recent ten-minute data points for further processing in a similar manner. For example, the six most recent ten-minute data points may be held to create each one-hour data point. This allows the processing entity to store various data points in the metrics database without retrieving data previously written to the metrics database. In some embodiments, each metric can be assigned a unique metric id which indexes a corresponding memory location in the cache.

According to specific embodiments, only one most recent data point at each resolution is cached. A “running tally” approach may be employed to compute each lower resolution data point from higher resolution data points. For example, suppose the cache only stores the most recent one-minute data point for a metric “cpu usage”, expressed as a percentage. When the first one-minute data point arrives, it is stored in the cache and also provided to the ten-minute aggregation function. The ten-minute aggregation function evaluates the value and saves a “running” result the ten-minute data point location in the cache. For instance, if the aggregation function is an averaging function SUM, it may simply store the value. In another example, the aggregation function MAX selects the maximum data point from the samples. When the next one-minute data point arrives, it is fed to the aggregation function. The aggregation function evaluates the new data point and the value stored in the ten-minute cache spot to determine the next result. For instance, the MAX aggregation function may compare the new data point to the stored data point, determine which one is larger, and store that result in the ten-minute location. Similarly, the SUM function may add the new data point to the value stored in the ten-minute cache location. At the end of the ten minute sampling period, the aggregation function determines a final result for that period. The MAX function would simply keep the value in the ten-minute cache location, since that value would be the largest of the ten one-minute data points it evaluated. Similarly, the SUM function would simply store the aggregated sum. An averaging function may divide its stored sum by the number of data points seen, in this case ten, to compute the average value.

Approaches to storage of time series data implemented in accordance with specific embodiments of the invention may also enable backfilling of data. Data arriving late or out of order can be processed and added to the database using the techniques described above. Similarly, large amounts of existing data, such as metrics collected previously going back several years, can be easily added to such systems by simply passing it to processing interface 201 with the appropriate timestamp.

In some embodiments, backfilling comes at the cost of bypassing the cache mechanism. Other embodiments include a special “backfill” mode of operation, whereby historical data can be added in sequence to utilize the cache. Certain embodiments even provide multiple caches for this purpose. When loading historical data from an external source, such as another database or set of RRDtool files, each external source is assigned its own cache called a load cache. The load cache only handles data from the source assigned to it. This allows efficient backfilling of data from multiple sources without disrupting the processing of real-time data in the primary cache. By contrast, conventional approaches such as RRDtool do not allow these backfilling behaviors, since the round-robin storage format employed by such tools does not easily incorporate data from past time periods.

At some point, data corresponding to various sampling rates may need to be removed due to storage constraints. Therefore, according to specific embodiments of the invention, each table may have a defined retention period for this purpose. For instance, the one-minute data points may be kept for a period of two weeks. This can be accomplished by periodically purging old entries, such a nightly process which removes entries older than the limit. Some embodiments employ an approach where each table only collects data for a certain period of time. For example, the one minute table 221 may be implemented as a collection of one-minute tables, one for each day. A table named 1M_{—}08012009 may hold the one-minute entries from Aug. 1, 2009, while a table 1M_{—}08022009 holds the one-minute entries from Aug. 2, 2009, and so on. Managing the retention periods then becomes simply a matter of dropping entire tables for periods beyond the retention window. For instance, assuming a two week retention period, the table 1M_{—}08012009 may be dropped after Aug. 15, 2009, while the table 1M_{—}08022009 may be dropped after Aug. 16, 2009. This approach saves the expense of evaluating the timestamp of every item in the database to find which entries are old enough to be purged. Another approach may drop the oldest table when a new table is created. The retention periods and sampling rates given are merely examples, as the system may accommodate any choices for these values.

In some embodiments of metrics database 203, data are grouped by profile. A profile is a collection of metrics related in some way. For instance, system administrators may want to monitor the health and performance of certain nodes, such as all the nodes in a cluster or all the nodes devoted to a certain task, like serving web requests. A profile called “operating system” may group together metrics related to this task, such as system load, cpu utilization, number of processes, input/output latency, etc. Similarly, a profile called “network health” may group together metrics such as network throughput, available bandwidth, number of connections served, number of dropped connections, and so on. Each profile may correspond to a set of one or more tables in metrics database 203. For example, tables 221-224 may store data for the “operating system” profile, while another set of tables (not shown) stores data for the “network health” profile. Data may be organized by profile, resource, neither, or both.

Profiles and resources are related but distinct. A profile is a set of metrics, while a resource is a set of dimensions describing nodes or services. For example, the aforementioned “web search” resource may be defined to encompass every node which responds to requests for urls containing the path /help/search.php. A profile may be thought of as identifying what the data is while a resource may be thought of as identifying where the data comes from. For convenience, resources may incorporate a metrics profile, such as including profile=name as one of a resource's key-value pairs. Such implementation techniques should not blur the logical distinction between a resource and a profile.

In some embodiments, such as that shown in FIG. 2, profiles are used implicitly. In such embodiments, tables in the database do not explicitly store a profile identifier; rather, an implicit profile can be determined from the choice of metrics stored in the table. For instance, if table 221 relates to the operating system profile, then it will store the metrics defined by that profile such as, for example, system load, cpu utilization, and so on. In practice, the profile name may be encoded in the name of the table itself. For instance, table 222 may be named NETWORK_{—}10M_{—}08012009 to indicate it stores metrics for the “network health” profile. The sampling rate and collection period may also be indicated by the table name, such as 10M to indicate samples every ten minutes and 08012009 to indicate data collected on Aug. 1, 2009.

Organizing metrics by profile improves locality of reference for reading and writing data. Analysis tools will typically analyze data centered around a certain task, such as system performance of individual nodes or network health of a cluster. Grouping these data by table allows the analysis tools to make fewer requests from the database, improving performance. Data for a given profile also tend to be reported together, creating locality of reference when organized in this way.

According to some embodiments, metrics tables such as 221 may be organized to allow for future growth. In one technique, table 221 preallocates more metrics columns than are currently needed. For instance, an operating system profile at one point in time may compromise three metrics: cpu utilization, memory usage, and average disk seek time. However, the system may allocate table 221 with space for five metrics: m1, m2, m3 (pictured) and m4, m5 (not shown). Columns m1, m2, and m3 will be used to store the three metrics in the operating system profile. Columns m4 and m5 will initially be empty. At a later point in time, an administrator may desire to add another metric such as network utilization to the operating system profile. The new metric can be stored in column m4 without changing the database schema.

Another technique for future growth that may be used with various embodiments involves segmenting metrics tables such as 221. Instead of storing metrics directly, a segmented table S contains pointers to other tables storing data. Table S may have columns for resource id and timestamp, as in table 221, and columns s1, s2, and s3 for segment pointers. These pointers indicate other tables storing the corresponding metrics data. Continuing the previous example, the three metrics from the original operating system profile may be stored in a first metric table T1, while table S stores a pointer to table T1 in the first segment column s1. More precisely, column s1 would hold a pointer to a row in T1 corresponding to each row in table S. Columns s2 and s3 would be unused at first since column s1 points to all the metrics for the profile. At a later time, two additional metrics may be added to the operating system profile. The new metrics can be stored in a second metrics table T2, with s2 holding a pointer to a corresponding row in T2. This enables flexibility in expanding metrics over time.

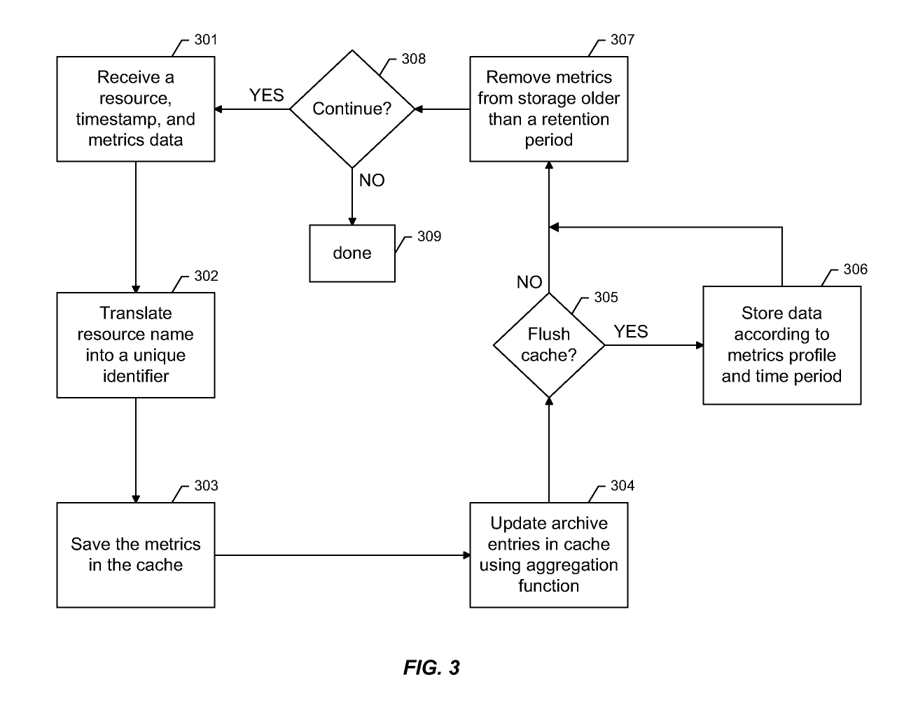

FIG. 3 illustrates a particular process for practicing embodiments of the invention. It should be noted that some of the depicted steps may be rearranged or omitted according to various embodiments without departing from the scope of the invention. The process begins when a processing entity (e.g., entity 120 of FIG. 1) receives data from a collection entity (301). In this example, the data includes a resource name, metrics data, and a timestamp indicating when the data were generated. As described, the resource name may comprise a set of key-value pairs characterizing the source of the data. The processing entity translates the resource name into an identifier suitable for use in a database (302). Assuming the metrics data are recent rather than stale, they are saved in a cache (303). Each metric name may be translated into a metric identifier which indexes into the cache. The cache may also contain archive entries which are created from higher-resolution data points as described elsewhere herein. Archive cache entries related to the received data are updated using a corresponding aggregation function (304) if required. This may include direct updates (e.g., updating a ten-minute data point on arrival of a one-minute data point), and cascading updates (e.g., updating a one-hour data point based on a ten-minute data point which was updated in response to arrival of a one-minute data point).

The process also determines whether to flush entries from the cache to storage (305). This may be triggered by various conditions according to the particular embodiment. Data may be flushed when a cache location becomes full, for instance on arrival of a fifth data point in a cache location with five spots. Alternately, data may be flushed every time a new data point arrives. In such a case, a cache may use a “running tally” aggregation function to construct archive data points, avoiding the need to read data back from storage. Another flushing strategy may specify a periodic data flush, such as every five minutes or half hour, to limit the amount of data that may be lost in a crash. Many such cache flushing strategies will be readily appreciated by those skilled in the art. In some embodiments, the flushing strategy may be aware of the timestamp received. If the timestamp received is of the current aggregation period, the current aggregate should be updated before flushing is considered. If the timestamp is older it should be flushed right away, and the update to persistent storage should call the aggregation function in question. If the timestamp is for a future time period, the current aggregated state should be flushed first and then the update should be performed.

When data is flushed from the cache to storage, or written directly to storage in embodiments without a cache, the data are stored in a metrics database (306). Database 203 in FIG. 2 provides one example of such a database. The metrics are stored along with the corresponding timestamp and resource identifier. According to some embodiments, metrics are organized in the database according to a profile as described herein. Further, the data are stored with reference to one or more associated time periods. For example, the metrics in tables 221-224 of FIG. 2 are organized according to their sampling rate: one minute, ten minutes, one hour, or six hours. Similarly, metrics data may be grouped into chunks of collection time for simpler management, such as maintaining a different one minute table for each day on which data are collected.

At certain times, older metrics which have passed their retention period are removed from the metrics database (307). For instance, this may occur as a daily task which drops tables whose collection date is older than their retention period. As an example, a table of one-minute data points covering the collection period Aug. 1, 2009 may be dropped after Aug. 15, 2009 assuming a retention period of two weeks. In some embodiments, older metrics may be purged from storage only when the cache is flushed for performance. As with caching strategies, those skilled in the art will comprehend numerous possible approaches to this type of administrative task. The process continues as the system is ready to receive metrics data again 301. Since the system is intended to gather time-series data continuously, the process may continue indefinitely 308.

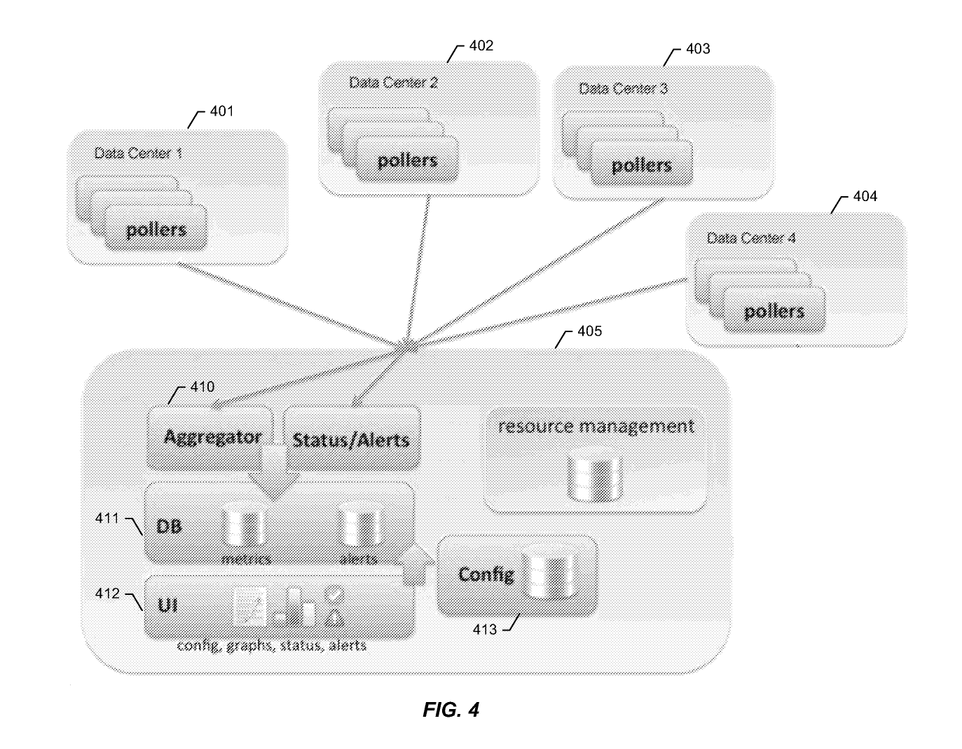

FIG. 4 shows a particular implementation of a data center monitoring system according to a specific embodiment of the invention. Four data centers 401-404 are represented by data centers 1-4. Each data center has a poller which gathers metrics data from nodes in that data center. These data are sent to facility 405 for processing. Facility 405 includes an aggregator 410 which collects the data and processes it for storage in a metrics database 411. The facility also performs other functions, such as managing resources and alerts in the data center. User interface 412 allows administrators to configure the collection, aggregation, and other functions performed by facility 405. Configuration data are saved in config database 413. The user interface may also be used to produce reports and graphs from metrics data stored in the system as well as monitor status and alerts.

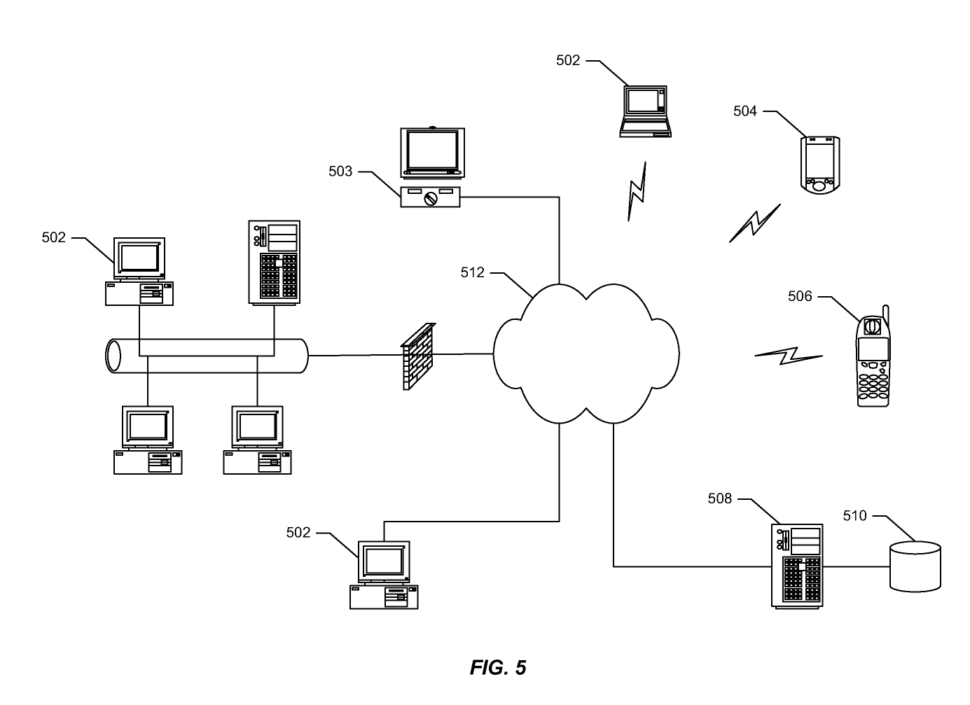

Embodiments of the present invention may be employed to collect and store time series data in any of a wide variety of computing contexts. For example, as illustrated in FIG. 5, implementations are contemplated in which the system interacts with a diverse network environment encompassing any type of computer (e.g., desktop, laptop, tablet, etc.) 502, media computing platforms 503 (e.g., cable and satellite set top boxes and digital video recorders), handheld computing devices (e.g., PDAs) 504, cell phones 506, or any other type of computing or communication platform. These devices may be producers or consumers of the data. As producers, the devices would comprise the nodes being monitored by the system. As an example, a device manufacturer may wish to gather monitoring data from its mobile devices in order to improve service. The devices may also indirectly produce the data by requesting services from nodes being monitored, such as accessing web and email services provided by a datacenter. As consumers, the devices may retrieve time series data stored in a metrics database to present reports, graphs, or other indications of the performance of nodes being monitored.

According to various embodiments, data processed in accordance with the invention may comprise any time series data, not just system metrics. The data may comprise any type of data such as text strings or numerical values. For example, time series data representing a user's interaction with a web site or web-based application or service (e.g., the number of page views, access times, durations, etc) may be collected using any of a variety of well known mechanisms for recording a user's online behavior. User data may be mined directly or indirectly, or inferred from data sets associated with any network or communication system on the Internet. And notwithstanding these examples, it should be understood that such types of time series data are merely exemplary and that time series data may be collected in many ways from numerous sources.

Once collected and stored, the data may be further processed in some centralized manner, such as by analysis engine 140 in FIG. 1, which may produce reports or graphs of the time series data. This is represented in FIG. 5 by server 508 and data store 510 which, as will be understood, may correspond to multiple distributed devices and data stores. The invention may also be practiced in a wide variety of network environments including, for example, TCP/IP-based networks, telecommunications networks, wireless networks, etc. These networks as well as the various communication systems from which connection data may be aggregated according to the invention are represented by network 512.

In addition, the computer program instructions with which embodiments of the invention are implemented may be stored in any type of computer-readable storage media, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for storing time series data comprising:
receiving a plurality of time series data from one or more computing clusters, each time series datum identifying one of a plurality of resources, an order in which the time series datum occurred, and one or more of a plurality of metrics by which the corresponding resource may be characterized;
aggregating the time series data in each of a plurality of sample intervals, wherein each of the sample intervals corresponds to one of a plurality of different time resolutions;
storing the time series data in a metrics database, wherein the time series data are organized according to the sample intervals, resource identifiers corresponding to the resources, and a plurality of profiles, each profile corresponding to a subset of the plurality of metrics;
removing expired time series data from the metrics database when a retention period associated with a corresponding one of the sample intervals is exceeded.

2. The method of claim 1 wherein the plurality of time series data comprises both existing data imported from another source and live data recently generated by the one or more computing clusters, wherein the aggregating and storing the existing data does not disrupt the aggregating and storing the live data in real-time.

3. The method of claim 1 wherein aggregating the time series data comprises using an aggregation function comprising one of (i) computing an average of data points, (ii) choosing a minimum or maximum data point, (iii) selecting a most recent data point, (iv) summing the data points, or (v) counting the number of data points.

4. The method of claim 1 further comprising allocating tables in the metrics database to store the time series data, wherein one or more of the tables are allocated with spare columns, the method further comprising storing additional metrics in the spare columns at a later time.

5. The method of claim 1 further comprising segmenting one or more tables allocated in the metrics database into partitions, wherein a first partition contains the resource identifiers and associated pointers to the other partitions, each of the other partitions containing the subsets of the metrics for the corresponding resources.

6. The method of claim 1 further comprising organizing the stored time series data according to specific time periods during which the time series data were collected.

7. A system for storing time series data comprising one or more computing devices configured to:
receive a plurality of time series data from one or more computing clusters, each time series datum identifying one of a plurality of resources, an order in which the time series datum occurred, and one or more of a plurality of metrics by which the corresponding resource may be characterized;
aggregate the time series data in each of a plurality of sample intervals, wherein each of the sample intervals corresponds to one of a plurality of different time resolutions;
store the time series data in a metrics database, wherein the time series data are organized according to the sample intervals, resource identifiers corresponding to the resources, and a plurality of profiles, each profile corresponding to a subset of the plurality of metrics;
remove expired time series data from the metrics database when a retention period associated with a corresponding one of the sample intervals is exceeded.

8. The system of claim 7 wherein the plurality of time series data comprises both existing data imported from another source and live data recently generated by the one or more computing clusters, wherein the aggregating and storing the existing data does not disrupt the aggregating and storing the live data in real-time.

9. The system of claim 7 wherein aggregating the time series data comprises using an aggregation function comprising one of (i) computing an average of data points, (ii) choosing a minimum or maximum data point, (iii) selecting a most recent data point, (iv) summing the data points, or (v) counting the number of data points.

10. The system of claim 7 further configured to allocate tables in the metrics database to store the time series data, wherein one or more of the tables are allocated with spare columns, the system further configured to store additional metrics in the spare columns at a later time.

11. The system of claim 7 further configured to segment one or more tables allocated in the metrics database into partitions, wherein a first partition contains the resource identifiers and associated pointers to the other partitions, each of the other partitions containing the subsets of the metrics for the corresponding resources.

12. The system of claim 7 further configured to organize the stored time series data according to specific time periods during which the time series data were collected.

13. The system of claim 7, further comprising a cache holding the most recent time series data.

14. A computer program product for storing time series data comprising at least one computer-readable storage medium having computer instructions stored therein which are configured to cause one or more computing devices to:
receive a plurality of time series data from one or more computing clusters, each time series datum identifying one of a plurality of resources, an order in which the time series datum occurred, and one or more of a plurality of metrics by which the corresponding resource may be characterized;
aggregate the time series data in each of a plurality of sample intervals, wherein each of the sample intervals corresponds to one of a plurality of different time resolutions;
store the time series data in a metrics database, wherein the time series data are organized according to the sample intervals, resource identifiers corresponding to the resources, and a plurality of profiles, each profile corresponding to a subset of the plurality of metrics;
remove expired time series data from the metrics database when a retention period associated with a corresponding one of the sample intervals is exceeded.

15. The computer program product of claim 14 wherein the plurality of time series data comprises both existing data imported from another source and live data recently generated by the one or more computing clusters, wherein the aggregating and storing the existing data does not disrupt the aggregating and storing the live data in real-time.

16. The computer program product of claim 14 wherein aggregating the time series data comprises using an aggregation function comprising one of (i) computing an average of data points, (ii) choosing a minimum or maximum data point, (iii) selecting a most recent data point, (iv) summing the data points, or (v) counting the number of data points.

17. The computer program product of claim 14 wherein the computer instructions are further configured to allocate tables in the metrics database to store the time series data, wherein one or more of the tables are allocated with spare columns, the system further configured to store additional metrics in the spare columns at a later time.

18. The computer program product of claim 14 wherein the computer instructions are further configured to segment one or more tables allocated in the metrics database into partitions, wherein a first partition contains the resource identifiers and associated pointers to the other partitions, each of the other partitions containing the subsets of the metrics for the corresponding resources.

19. The computer program product of claim 14 wherein the computer instructions are further configured to organize the stored time series data according to specific time periods during which the time series data were collected.
